(19) United States
(12) Patent Application Publication
(10) Pub. No.: US 2024/0110598 A1
(43) Pub. Date: Apr. 4, 2024

(54) Sealing Structure for a Bearing Unit

(71) Applicant: AKTIEBOLAGET SKF, Götenborg (SE)

(72) Inventors: Guo Jiang Zhang, Shanghai (CN); Bo Han, Shanghai (CN); Li Jing Zhang, Qingdao City (CN)

(21) Appl. No.: 18/244,930

(22) Filed: Sep. 12, 2023

(30) Foreign Application Priority Data
Sep. 30, 2022 (CN) 202211209067.7

(51) Int. Cl. F16C 33/78

(52) U.S. Cl. CPC F16C 33/7823

(57) ABSTRACT

A bearing unit includes a radially inner ring, a radially outer ring comprising a lubricant inlet, a plurality of rolling bodies interposed between the inner ring and the outer ring, and a first seal. The first seal includes an axially outer sealing ring, an axially inner sealing ring, and a first sealing lip formed on an axially inner surface of the axially inner sealing ring and extending axially inward to make sealing contact with an axially outer surface of the axially inner sealing ring. The first sealing lip prevents lubricant from flowing from an interior of the bearing unit to an exterior of the bearing unit at a first axial end of the bearing unit, and the first seal is disposed axially outside the inlet of the radially outer ring.

### CROSS-REFERENCE RELATED APPLICATIONS

This application is based on and claims priority to China Patent Application No. 202211209067.7 filed on Sep. 30, 2022, under 35 U.S.C. § 119, the disclosure of which is incorporated by reference herein.

### FIELD

The disclosure relates to a sealing structure for a bearing unit and a bearing unit including the sealing structure.

### SUMMARY

In some embodiments, a sealing structure may include a first seal. The first seal may include a first sealing ring, a second sealing ring, and a first sealing lip formed on a surface of the first sealing ring and extending toward the second sealing ring to make sealing contact with an inner surface of the second sealing ring. In the first sealing lip may be configured to prevent lubricant from flowing from an interior of a bearing unit to an exterior of a bearing unit at a first axial end of the bearing unit.

In some embodiments, a strength of the sealing contact between the inner surface of the second sealing ring increases directly with a strength of the lubricant flow.

In some embodiments, the second sealing ring of the first seal of the sealing structure may further include a skeleton having an end portion configured to be perpendicular to a central axis of rotation of the bearing unit. The first sealing lip may further be disposed in sealing contact with an inner surface of the end portion of the skeleton.

In some embodiments, the second sealing ring may further include a ring lip extending from an outer surface of the end portion of the skeleton of the second sealing ring. The ring lip may be configured to contact an inner ring of the bearing unit and allow lubricant to flow to a space between the first sealing ring and the second sealing ring.

In some embodiments, the first sealing ring may also include a second sealing lip connected to the inner side surface of the first sealing ring. The second sealing lip may be in sealing contact with an inner surface of the end portion of the second sealing ring. The second sealing lip may be configured to allow lubricant to flow from the end portion of the skeleton of the second sealing ring to an end of the skeleton distal to the end portion of the skeleton, and may be disposed downstream of the leak-proof sealing lip with respect to a potential flow direction of lubricant.

In some embodiments, the sealing structure may also include a second seal configured to allow lubricant to flow from an interior of the bearing unit to an exterior of the bearing unit at a second axial end of the bearing unit distal to the first axial end.

In other embodiments, a sealing structure may include a first seal having a first sealing ring and a first sealing lip formed on a first surface of the first sealing ring and extending therefrom. The first sealing lip may be configured to make sealing contact with at least one of an inner ring of a bearing unit, a shaft, a shaft sleeve, and an inner wall of a bearing housing, and be configured to prevent lubricant from flowing from an interior of a bearing unit to an exterior of a bearing unit at a first axial end of the bearing unit. In some embodiments, a strength of the sealing contact between the first sealing ring and the at least one of the inner ring of the bearing unit, the shaft, the shaft sleeve, and the inner wall of a bearing housing may increase directly with a strength of the lubricant flow.

In some embodiments, the first sealing ring of the first seal may include a skeleton and the first sealing lip may be connected to a side surface of the skeleton.

In some embodiments, the sealing structure may further include a second seal configured to allow lubricant to flow from an interior of the bearing unit to an exterior of the bearing unit at a second axial end of the bearing unit distal to the first axial end.

In some embodiments, the first sealing lip may be configured to extend at an incline with respect to a central axis of rotation of the bearing unit.

In some embodiments, a bearing unit may include a radially inner ring, a radially outer ring having a lubricant inlet, a plurality of rolling bodies interposed between the inner ring and the outer ring, and a first seal. The first seal may include an axially outer sealing ring, an axially inner sealing ring, and a first sealing lip formed on an axially inner surface of the axially inner sealing ring and extending axially inward to make sealing contact with an axially outer surface of the axially inner sealing ring. In some embodiments, the first sealing lip may prevent lubricant from flowing from an interior of the bearing unit to an exterior of the bearing unit at a first axial end of the bearing unit, and the first seal may be disposed axially outside the inlet of the radially outer ring.

In some embodiments, the radially outer ring of the bearing unit may further include an annular lubricant groove formed on an outer peripheral surface of the radially outer ring, and the lubricant groove may be disposed annularly in the annular lubricant groove.

In some embodiments, a strength of the sealing contact between the inner surface of the axially inner sealing ring may increase directly with a strength of a lubricant flow from the interior of the bearing unit to the exterior of the bearing unit at the first axial end of the bearing unit.

In some embodiments, the axially inner sealing ring of the bearing unit may further include a skeleton comprising a radially inner end portion formed perpendicular to a central axis of rotation of the bearing unit, and the first sealing lip may be in sealing contact with an axially outer side surface of the skeleton.

In some embodiments, the axially inner sealing ring may also include a ring lip extending from an axially outer surface of the end portion of the skeleton of the axially inner sealing ring. The ring lip may contact the radially inner ring of the bearing unit and allow lubricant to flow to a space between the axially inner sealing ring and the axially outer sealing ring.

In some embodiments, the axially outer sealing ring may also include a second sealing lip connected to the inner side surface of the axially outer sealing ring, wherein the second sealing lip is in sealing contact with an inner surface of the radially inner end portion of the axially inner sealing ring. The second sealing lip may allow lubricant to flow from the radially inner end portion of the skeleton of the axially inner sealing ring to an axially outer end portion of the skeleton distal to the axially inner end portion. The second sealing lip may be disposed radially outside of the first sealing lip with respect to a flow direction of lubricant from the interior of the bearing unit to the exterior of the bearing unit.

In some embodiments, the bearing unit may further include a second seal disposed at a second axial end of the bearing unit distal to the first axial end, wherein the second seal allows lubricant to flow from the interior of the bearing unit to the exterior of the bearing unit at the second axial end of the bearing unit.

### BRIEF DESCRIPTION OF THE DRAWINGS

FIG. 1 is a first schematic view of a sealing structure and a bearing according to exemplary embodiments of the present disclosure;

FIG. 2 is an enlarged schematic view of the sealing structure of FIG. 1 according to exemplary embodiments of the present disclosure;

FIG. 3 is a second schematic view of a sealing structure and a bearing according to exemplary embodiments of the present disclosure; and

FIG. 4 is a schematic diagram showing an overall structure of a bearing according to exemplary embodiments of the present disclosure.

### DETAILED DESCRIPTION

In bearing units, it is frequently necessary to supply lubricant intermittently into internal components of the bearing unit. To keep lubricant in and keep contaminants out, the bearing units include sealing structures. These sealing structures are often symmetrical structures, that is, that include identical seals disposed symmetrically on both axial ends of the bearing unit. Contact lips of these sealing structure may be open outwardly (i.e., toward an exterior of the bearing unit), which ensures that the lubricant can be discharged out of the bearing unit on both axial ends of the bearing unit. This can prevent excessive accumulation of lubricant in the interior of the bearing unit, which may adversely affect the sealing effect of the sealing structures and operation of the bearing unit.

During operation, the discharged lubricant may come into contact with other materials, for example other materials transported on a production line where the bearing unit is used, and can contaminate those materials. In instances, the contaminated materials must be discarded, which can cause significant losses for customers who use such bearing units. This can be especially concerning in bearing units used in food and beverage industry, as the contamination of food and beverage products by lubricant discharged from bearing unit may result in serious food safety problems.

Known solutions include bearing units that cannot expel any lubricant from the interior of the bearing unit and that are not able to be re-lubricated for concerns of contaminating other materials. Thus, customers are forced to sacrifice the service life of the bearing unit for the safety and protection of other materials in a product line, increasing expenses as customers are required to replace the bearing units more frequently. Therefore, a technical solution is needed to solve the problem of material contamination caused by lubricant discharged from both sides of the bearing, and at the same time, allow for re-lubrication of the bearing unit to increase the service life thereof.

In view of this, the present disclosure provides a bearing unit with an asymmetric sealing structure that allows for re-lubrication of the bearing unit by facilitating expulsion of lubricant from the interior of the bearing unit from a designated axial end of the bearing unit while preventing expulsion of lubricant form the opposite axial end of the bearing unit. This reduced the risk of lubricant contaminating other materials outside the bearing unit by providing control over which axial end of the bearing unit lubricant may be expelled from.

For convenience of explanation, the direction of the central axis of rotation the bearing unit is called the axial direction, the direction perpendicular to the axial direction is called the radial direction, and the direction of the rotation of the bearing unit is called the circumferential direction. The terms “inner” and “inward” refer to the direction toward a center of the bearing unit, whereas the terms “outer” and “outward” refer to the direction away from the center of the bearing unit.

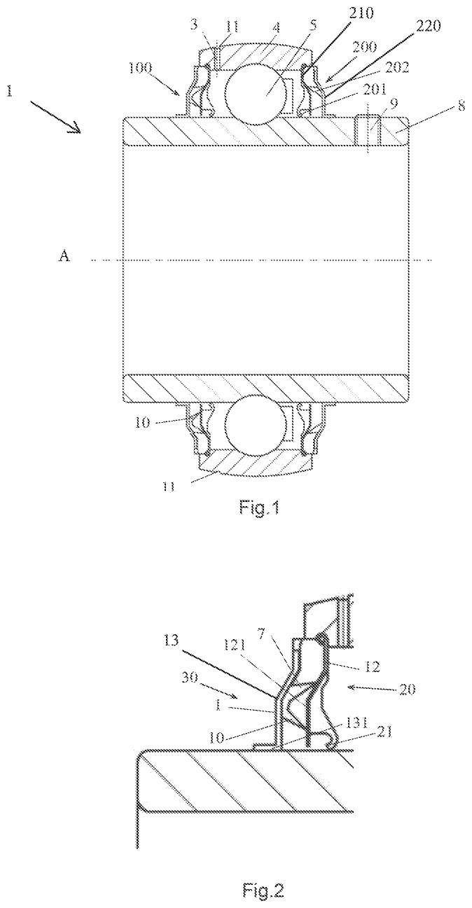

With reference to FIGS. 1-4, a sealing structure for a bearing unit according to exemplary embodiments of the present disclosure will be described. In exemplary embodiments illustrated in the figures, a bearing unit, e.g., a bearing unit 1, is shown as a Y-shaped bearing unit. Such embodiments may be applicable to applications where there is high risk for external contamination and where the desired running speed of the bearing unit is low. However, reference to the Y-shaped bearing unit is in no way meant to be limiting, and a person of ordinary skill in the art will appreciate that use of a Y-shaped bearing is merely exemplary and that numerous alternative types of bearing units may be used without departing from the teachings of this disclosure.

In some embodiments, a bearing unit 1 may include an outer ring 4, an inner ring 8, a plurality of rolling elements 5 interposed between outer ring 4 and inner ring 8, and a locking nut 9. Bearing unit 1 may further include a lubricant inlet 3 disposed radially outside of rolling elements 5. In some embodiments, outer ring 4 may include an annular lubricant groove 11 formed on an outer peripheral surface thereof (see, e.g. FIG. 4). In some embodiments, lubricant inlet 3 may be disposed inside lubricant groove 11, whereby lubricant groove 11 may guide lubricant to lubricant inlet 3. In some embodiments, rolling elements 5 may be balls, cylindrical rollers, tapered rollers, or other known rolling elements.

In some embodiments, bearing unit 1 may include a sealing structure that may include a first seal 100 and a second seal 200. In some embodiments, first seal 100 may be disposed axially outside lubricant inlet 3 in order to seal bearing unit 1. In some embodiments, first seal 100 may include a leak-proof sealing lip 10. When lubricant is replenished into bearing unit 1 through lubricant inlet 3, leak-proof sealing lip 10 prevents leakage of lubricant out of bearing unit 1 on the same axial side as lubricant inlet 3.

In some embodiments, first seal 100 may include an axially inner sealing ring 20 and an axially outer sealing ring 30. Leak-proof sealing lip 10 may be connected to an axially inner side surface of outer sealing ring 30 and may be in sealing contact with an axially outer side surface of inner sealing ring 20. In some embodiments, sealing lip 10 may be connected to outer sealing ring 30 by molding vulcanization, bonding, injection, or the like. By configuring sealing lip 10 to extend in the axially inward direction and be in sealing contact with the axially outer surface of inner sealing ring 20, force from a flow of lubricant can press the leak-proof sealing lip 10 against the axially outer side surface of inner sealing lip 20, as described in greater detail in this disclosure.

In some embodiments, inner sealing ring 20 may include a skeleton 12 that may include a radially inner end portion 121. In some embodiments, a radially inner end portion 121 may be perpendicular with respect to the axial direction, and leak-proof sealing lip 10 may be disposed in sealing contact with a radially inner end portion 121 of skeleton 12. In such embodiments, leak-proof sealing lip 10 may extend in an axially inward direction from an axially inner side surface of outer sealing ring 30 at an incline with respect to a central axis A of bearing unit 1 and extend in a radially inward direction. In some embodiments, sealing lip 10 may have a wedge-shaped radial cross section.

A portion of an axially outer side surface of skeleton 12 of inner sealing ring 20 may be inclined with respect to central axis A. In some embodiments, the portion of the axially outer side surface of skeleton 12 may be inclined at the same angle as leak-proof sealing lip 10 is with respect to central axis A of bearing unit 1. In some embodiments, leak-proof sealing lip 10 may abut the inclined portion of the axially outer side surface of skeleton 12, resulting in an increased area of contact between the sealing lip 10 and skeleton 12 resulting from the fact that the inclined portion of the axially outer surface and the leak-proof sealing lip are inclined at the same angle with respect to central axis A of bearing unit 1. When under pressure from the lubricant in the interior of bearing unit 1, leak-proof sealing lip 10 can press against the axially outer surface of skeleton 12 more tightly and with a greater surface area, improving the sealing effect therewith and thereby preventing lubricant from exiting the interior of bearing unit 1.

In some embodiments, inner sealing ring 20 may further include an inner ring lip 21 that allows lubricant to flow to a space between inner sealing ring 20 and outer sealing ring 30. In some embodiments, inner ring lip 21 may be have a form that does not block the lubricant flow from inlet 3 and into an interior of bearing unit 1. In some embodiments, inner ring lip 21 may include an edge bent in an axially outward direction toward an exterior of bearing unit 1.

When lubricant is replenished into bearing unit 1 through lubricant inlet 3, as pressure caused by the lubricant increases in bearing unit 1, the lubricant will push the inner ring lip 21 open (i.e., in an axially outward direction) and flow into the space between inner sealing ring 20 and outer sealing ring 30. However, due to the sealing contact between the leak-proof sealing lip 10 and outer side surface 121 of skeleton 12 of inner sealing ring 20, the lubricant will not be able to push leak-proof sealing lip 10 open. The increasing pressure generated by the lubricant in bearing unit 1 further presses leak-proof sealing lip 10 tightly against radially inner end portion 121 of skeleton 12, and the greater the pressure, the tighter the contact between leak-proof sealing lip 10 and radially inner end portion 121 of skeleton 12. Thus, the configuration of inner sealing ring 20, outer sealing ring 30, and leak-proof sealing lip 10 greatly reduces the amount of lubricant able to leak from the same axial side of bearing unit 10 on which first seal 100 is placed.

In alternative embodiments, leak-proof sealing lip 10 may be disposed on inner sealing ring 20. Specifically, in such embodiments, leak-proof sealing lip 10 may be connected to an axially outer side surface of inner sealing ring 20 and in sealing contact with an axially inner side surface of outer sealing ring 30, so that when lubricant flows from inlet 3 to leak-proof sealing lip 10, the lubricant further presses leak-proof sealing lip 10 tightly against the axially inner side surface of outer sealing ring 30. In this case, leak-proof sealing lip 10 may extend axially outward from the axially outer side surface of inner sealing ring 20 at an incline with respect to central axis A of bearing unit 1 and extend in the radially inward direction. Further, in such embodiments, a portion of an inner side surface of outer sealing ring 30 may also be inclined with respect to central axis A of bearing unit 1. In some embodiments, the inclined portion of the inner side surface of outer ring 30 may be inclined at the same angle as leak-proof sealing lip 10 is inclined with respect to central axis A of bearing unit 1.

In some embodiments in which leak-proof sealing lip 10 is disposed on inner sealing ring 20, outer sealing ring 30 may include a skeleton 13 having an radially inner end portion 131. In such embodiments, leak proof sealing lip 10 may be in sealing contact with radially inner end portion 131.

In still further embodiments, first seal 100 may include two leak-proof sealing lips 10, where a first leak-proof sealing lip 10 may be disposed on inner sealing ring 20 and a second leak-proof sealing lip 10 may be disposed on outer ring 30 as described above, further improving the sealing effect.

It should be understood that the form of the first seal 100 is not particularly limited, and it may include sealing rings 20, 30 with a respective skeleton 12, 13 as described above, or may include sealing rings 20, 30 without a respective skeleton. Moreover, leak-proof sealing lip 10 may be implemented in various ways, and the number or the specific shape thereof is not particularly limited.

In some embodiments, bearing unit 1 may also include a second seal 200 on a side of bearing unit 1 axially opposite first seal 100 such that rolling element 5 resides axially between first seal 100 and second seal 200. In some embodiments, second seal 200 may allow lubricant to flow out of the interior of bearing unit 1.

In some embodiments, second seal 200 may include an inner sealing ring 210 having a skeleton and an outer sealing ring 220 having a skeleton. An inner ring lip 201 may be disposed on an axially inner side surface of inner sealing ring 210, and a dust-proof sealing lip 202 may be disposed on the inner side surface of outer sealing ring 220. The inner ring lip 201 and the dust-proof sealing lip 202 of the second seal 200 may be disposed so as not to hinder flow of lubricant from the interior of bearing unit 1 to an exterior of bearing unit 1. With this structure, when an internal pressure of bearing unit 1 caused by the lubricant increases, which may be due to re-lubrication, inner ring lip 201 can be pushed open by the pressure from the lubricant, so that the lubricant flows into space between inner sealing ring 210 and outer sealing ring 220 of second seal 200, and further pushes dust-proof sealing lip 202 open to allow lubricant to flow out of the interior of bearing unit 1.

It can be seen that, through the asymmetric sealing structure of embodiments of the present disclosure, when lubricant flows through lubricant inlet 3 and into the interior of bearing unit 1, the lubricant can only flow out to the exterior of the bearing unit 1 from a desired side of bearing unit 1, which may be either axial side of bearing unit 1, due to interior pressure resulting from the lubricant. This allows for the selection of a desired discharge side of bearing unit 1 and ensures that the lubricant may only be discharged from the desired discharge side and zero, or at least greatly reduced, discharge from the opposite axial side. In this way, the present disclosure provides an asymmetric sealing structure to allow lubricant to flow around rolling elements 5 and out of bearing unit 1 from the axial side of second seal 200. The sealing structure effectively prevents the lubricant from leaking on the axial side of first seal 100 and contaminating materials, and ensures that bearing unit 1 is sufficiently lubricated to prolong the service life thereof.

In some embodiments, outer sealing ring 30 of first seal 100 may include a dust-proof sealing lip 7 (which may be similar to dust-proof sealing lip 202 of second seal) connected to the inner side surface of outer sealing ring 30 and dust-proof sealing lip 7 may be in sealing contact with axially outer side surface 121 of skeleton 12. In such embodiments, dust-proof sealing lip 7 may be disposed so as not to hinder the lubricant from flowing out of the interior of bearing unit 1 and to the exterior of bearing unit 1. Moreover, dust-proof sealing lip 7 may be disposed downstream of leak-proof sealing lip 10 with respect to the flow direction of the lubricant out of the interior of bearing unit 1 (e.g., in a radially outward direction whereby dust-proof sealing lip 7 is positioned in an axially outer position relative to leak-proof sealing lip 10).

In alternative embodiments, dust-proof sealing lip 7 may be disposed on axially outer side surface 121 of skeleton 12 of inner sealing ring 20 and may be in sealing contact with radially inner end portion 131 of skeleton 13 of outer sealing ring 30. In such embodiments, dust-proof sealing lip 7 may be disposed downstream of leak-proof sealing lip 10 with respect to the flow direction of the lubricant out of the interior of bearing unit 1 (e.g., in a radially outward direction whereby dust-proof sealing lip 7 is positioned in an axially outer position relative to leak-proof sealing lip 10).

It should also be understood that, although the illustrated bearing unit, e.g., bearing unit 1, may be a Y-shaped bearing (commonly referred to as a bearing with a seat), the sealing structure of the present disclosure is suitable for any type of bearing unit with an inlet, e.g., lubricant inlet 3, for lubrication. For example, bearing unit 1 may have a single-row of rolling elements, a double-row of rolling elements, or a multi-row of rolling elements and is suitable for a combined bearing including a plurality of bearings with an inlet for lubricant. In some embodiments, the rolling elements may be balls, cylindrical rollers, tapered rollers, or other known rolling elements.

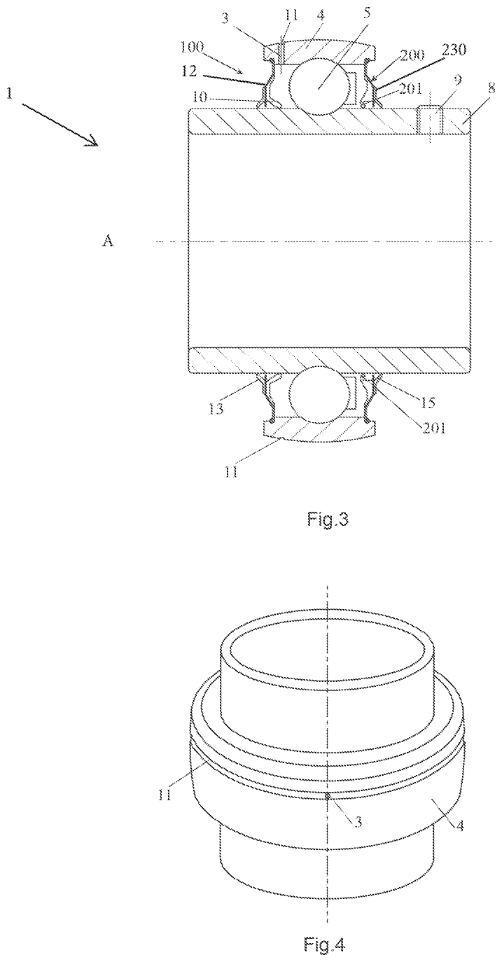

As illustrated in FIG. 3, exemplary embodiments of a bearing unit 1 including a sealing structure with a simplified first seal 100 and a simplified second seal 200.

In some embodiments, a first seal 100 may be provided as a singular sealing ring made up of a skeleton 12. A leak-proof sealing lip 10 may be connected to an axially inner side surface of skeleton 12 and be disposed such that leak-proof sealing lip 10 presses against inner ring 8 of bearing unit 1 when lubricant flows from inlet 3 into an interior of bearing unit 1.

In some embodiments, leak-proof sealing lip 10 may include a radially inner portion that extends from skeleton 12 radially inward toward inner ring 8 at an incline with respect to central axis A of bearing unit 1, forming a seal between an outer peripheral surface of inner ring 8 and the radially inner portion of skeleton 12. As pressure from the lubricant builds in the interior of bearing unit 1, leak-proof sealing lip 10 presses against inner ring 8, creating a seal therewith and preventing lubricant from traveling through an exterior of bearing unit 1 on a same axial side as first seal 100. As the pressure increases, the strength of the seal formed between leak-proof sealing lip 10 and inner ring 8 increases.

In some embodiments, bearing unit 1 may also include a second seal 200 formed by a single sealing ring 230 having a skeleton that includes a lip 201 formed on an axially inner side surface of the skeleton. As discussed above, lip 201 is disposed on the skeleton of second seal 200 so that lubricant may flow from the interior of bearing unit 1 to the exterior of bearing unit 1 through the same axial side of bearing unit 1 as second seal 200. When lubricant builds up in the interior, pressure therefrom pushes lip 201 of second seal 200 axially outward, allowing lubricant to flow out of the interior of bearing unit 1.

In some embodiments, first seal 100 may further include a dust-proof sealing lip 13 formed on an axially outer side surface of skeleton 12, and second seal 200 may also include a dust-proof sealing lip 15 formed on an axially outer side surface outside of its skeleton. In some embodiments, dust-proof sealing lips 13 and 15 may be in contact with an outer peripheral surface of inner ring 8 to provide additional sealing effect that prevents contaminants from entering an interior of bearing unit 1 from the external environment.

It should be understood that although leak-proof sealing lip 10 is disposed in sealing contact with inner ring 8 of bearing unit 1 in the various embodiments shown in the figures (i.e., when bearing unit 1 is not a Y-shaped bearing as shown in the exemplary embodiments illustrated in FIGS. 1-4), first seal 100 may be installed as required on various other components other than an inner ring, and leak-proof sealing lip 10 may be disposed in sealing contact with such appropriate components. Therefore, the component may be the bearing inner ring 8 as mentioned above, or it may be a shaft, a shaft sleeve, or an inner wall of a bearing housing, to which a bearing is sleeved.

It should be understood that embodiments of leak-proof sealing lip 10 are not restricted to those described herein. In other embodiments, leak-proof sealing lip 10 may have any suitable shape and form, such as but not limited to, a circular arc cross-section, a trapezoidal cross-section, or a rectangular cross-section, in addition to the wedge-shaped cross-section as described herein. In addition, the materials of each sealing lip may be selected in various ways depending on desired characteristics. In some embodiments, each sealing lip may be made of, for example, nitrile rubber, hydrogenated nitrile rubber, polyurethane, silicone rubber, fluorine rubber, ethylene propylene rubber, polytetrafluoroethylene, polyoxymethylene and/or other polymer elastomers, or any combination thereof.

Furthermore, the disclosure also provides a bearing, which may include the sealing structure as mentioned above.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

It should be noted that the use of particular terminology when describing certain features or aspects of the disclosure should not be taken to imply that the terminology is being redefined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements; the term “having” should be interpreted as “having at least;” the term “such as” should be interpreted as “such as, without limitation;” the term ‘includes” should be interpreted as “includes but is not limited to”. The term “example” or the abbreviation “e.g.” is used to provide exemplary instances of the item in discussion, not an exhaustive or limiting list thereof, and should be interpreted as “example, but without limitation”. The term “illustration” or related terms is used to provide exemplary instances of the item in discussion, not an exhaustive or limiting list thereof, and should be interpreted as “illustration, but without limitation.” Adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

We claim:

1. A sealing structure comprising:
a first seal comprising:
a first sealing ring;
a second sealing ring;
a first sealing lip formed on a surface of the first sealing ring and extending toward the second sealing ring to make sealing contact with an inner surface of the second sealing ring,
wherein the first sealing lip is configured to prevent lubricant from flowing from an interior of a bearing unit to an exterior of a bearing unit at a first axial end of the bearing unit.

2. The sealing structure of claim 1, wherein a strength of the sealing contact between the inner surface of the second sealing ring increases directly with a strength of the lubricant flow.

3. The sealing structure of claim 2, wherein,
the second sealing ring further comprises a skeleton comprising an end portion configured to be perpendicular to a central axis of rotation of the bearing unit, and
the first sealing lip is disposed in sealing contact with an inner surface of the end portion of the skeleton.

4. The sealing structure of claim 3, wherein the second sealing ring further comprises a ring lip extending from an outer surface of the end portion of the skeleton of the second sealing ring, and wherein the ring lip is configured to contact an inner ring of the bearing unit and to allow lubricant to flow to a space between the first sealing ring and the second sealing ring.

5. The sealing structure of claim 3, wherein,
the first sealing ring further comprises:
a second sealing lip connected to the inner side surface of the first sealing ring, wherein,
the second sealing lip is in sealing contact with an inner surface of the end portion of the second sealing ring,
the second sealing lip is configured to allow lubricant to flow from the end portion of the skeleton of the second sealing ring to an end of the skeleton distal to the end portion of the skeleton, and
the second sealing lip is disposed downstream of the leak-proof sealing lip with respect to a potential flow direction of lubricant.

6. The sealing structure of claim 5, further comprising:
a second seal configured to allow lubricant to flow from an interior of the bearing unit to an exterior of the bearing unit at a second axial end of the bearing unit distal to the first axial end.

7. A sealing structure comprising:
a first seal comprising:
a first sealing ring;
a first sealing lip formed on a first surface of the first sealing ring and extending therefrom, wherein,
the first sealing lip is configured to make sealing contact with at least one of an inner ring of a bearing unit, a shaft, a shaft sleeve, and an inner wall of a bearing housing,
the first sealing lip is configured to prevent lubricant from flowing from an interior of a bearing unit to an exterior of a bearing unit at a first axial end of the bearing unit, and
a strength of the sealing contact between the first sealing ring and the at least one of the inner ring of the bearing unit, the shaft, the shaft sleeve, and the inner wall of a bearing housing increases directly with a strength of the lubricant flow.

8. The sealing structure of claim 7, wherein the first sealing ring comprises a skeleton, and the first sealing lip is connected to a side surface of the skeleton.

9. The sealing structure according to claim 8, further comprising a second seal configured to allow lubricant to flow from an interior of the bearing unit to an exterior of the bearing unit at a second axial end of the bearing unit distal to the first axial end.

10. The sealing structure of claim 9, wherein the first sealing lip is configured to extend at an incline with respect to a central axis of rotation of the bearing unit.

11. A bearing unit comprising:
a radially inner ring;
a radially outer ring comprising a lubricant inlet;
a plurality of rolling bodies interposed between the inner ring and the outer ring;
a first seal comprising:
an axially outer sealing ring;
an axially inner sealing ring;
a first sealing lip formed on an axially inner surface of the axially inner sealing ring and extending axially inward to make sealing contact with an axially outer surface of the axially inner sealing ring,
wherein,
the first sealing lip prevents lubricant from flowing from an interior of the bearing unit to an exterior of the bearing unit at a first axial end of the bearing unit, and
the first seal is disposed axially outside the inlet of the radially outer ring.

12. The bearing unit of claim 11, wherein,
the radially outer ring further comprises an annular lubricant groove formed on an outer peripheral surface of the radially outer ring,
wherein the lubricant groove is disposed annularly in the annular lubricant groove.

13. The bearing unit of claim 12, wherein a strength of the sealing contact between the inner surface of the axially inner sealing ring increases directly with a strength of a lubricant flow from the interior of the bearing unit to the exterior of the bearing unit at the first axial end of the bearing unit.

14. The bearing unit of claim 13, wherein,
the axially inner sealing ring further comprises a skeleton comprising a radially inner end portion formed perpendicular to a central axis of rotation of the bearing unit, and
the first sealing lip is in sealing contact with an axially outer side surface of the skeleton.

15. The bearing unit of claim 14, wherein the axially inner sealing ring further comprises a ring lip extending from an axially outer surface of the end portion of the skeleton of the axially inner sealing ring, and wherein the ring lip contacts the radially inner ring of the bearing unit and allows lubricant to flow to a space between the axially inner sealing ring and the axially outer sealing ring.

16. The bearing unit of claim 15, wherein, the axially outer sealing ring further comprises:
a second sealing lip connected to the inner side surface of the axially outer sealing ring, wherein,
the second sealing lip is in sealing contact with an inner surface of the radially inner end portion of the axially inner sealing ring,
the second sealing lip allows lubricant to flow from the radially inner end portion of the skeleton of the axially inner sealing ring to an axially outer end portion of the skeleton distal to the axially inner end portion, and
the second sealing lip is disposed radially outside of the first sealing lip with respect to a flow direction of lubricant from the interior of the bearing unit to the exterior of the bearing unit.

17. The sealing structure of claim 16, further comprising:
a second seal disposed at a second axial end of the bearing unit distal to the first axial end, wherein the second seal allows lubricant to flow from the interior of the bearing unit to the exterior of the bearing unit at the second axial end of the bearing unit.
